(19) United States
(12) Patent Application Publication
(10) Pub. No.: US 2008/0053096 A1
(43) Pub. Date: Mar. 6, 2008

(54) Fuel injection system and method of assembly

(75) Inventors: Oleg Morenko, Oakville (CA); Bhawan B. Patel, Mississauga (CA); Nagaraja Rudrapatna, Mississauga (CA)

Correspondence Address: OGILVY RENAULT LLP (PWC), 1981 MCGILL COLLEGE AVENUE, SUITE 1600, MONTREAL, QC, H3A 2Y3, US

(73) Assignee: Pratt & Whitney Canada Corp.

(21) Appl. No.: 11/513,030

(22) Filed: Aug. 31, 2006

(51) Int. Cl. F02C 1/00

(52) U.S. Cl. 60/734; 60/739

(57) ABSTRACT

A fuel injection system comprises a fuel conveying member and a nozzle tip assembly threadedly engaged thereto. A sealing element is engaged in a first fuel passage between the fuel conveying member and the nozzle tip for sealing a first junction therebetween.

### TECHNICAL FIELD

The invention relates generally to a gas turbine engine and, more particularly, to an improved fuel injection system.

### BACKGROUND OF THE ART

A gas turbine engine may have an internal manifold with attached fuel nozzle tips. Often, a fastening/sealing method such as a brazing process is utilized in order to achieve a rigid joint between the fuel conveying member and the nozzle tips that does not introduce a leak during engine operation. In order to achieve a high quality brazing joint, precision machining of the mating components is required which is costly for the manufacturers. Furthermore, the use of an expensive brazing paste is necessary to carry out the brazing process. Due to a very small parts size, particularly in smaller gas turbine engines, the assembly operation is time consuming and requires a highly skilled technician to do the work. Once a nozzle tip is assembled, it is very difficult and often not at all possible to overhaul the nozzle tip or fuel conveying member if necessary. Consequently, one damaged nozzle tip could be a reason to scrap the nozzle or entire internal manifold.

Accordingly, there is a need to provide an improved fuel injection system for simplifying overall manufacturing, assembly, and for reducing costs.

### SUMMARY OF THE INVENTION

It is therefore an object of this invention to improve the design, manufacturing and assembly of fuel nozzle tips.

In one aspect, the present invention provides a fuel injection system comprising a fuel conveying member and a nozzle tip threadably engaged thereto, the fuel conveying member and the nozzle tip defining at least a first fuel passage therebetween, and at least one sealing element engaged in the first fuel passage for sealing a first junction between the fuel conveying member and the nozzle tip assembly.

In a second aspect, the present invention provides a fuel injection system for a gas turbine engine comprising a manifold ring adapted for installation inside a gas turbine engine having a plurality of circumferentially distributed nozzle tip receiving sites, the manifold ring including at least one fuel transporting conduit defined therein in communication with each of the nozzle tip receiving sites; a plurality of nozzle tip assemblies mounted about the manifold ring, each nozzle tip assembly being threadedly engaged in the nozzle tip receiving site and in fluid communication with the fuel transporting conduit; at least a first fuel passage defined between the manifold ring and each nozzle tip assembly; and at least one sealing element compressively engaged in the first fuel passage between a first compression surface defined by the manifold ring and a second compression surface defined by the nozzle tip assembly for sealing a first junction therebetween.

In a third aspect, the present invention provides a method of assembling a nozzle tip assembly to a fuel conveying member of a fuel injection system in a gas turbine engine, comprising the steps of positioning at least one sealing element in abutment with a first abutting surface defined in the fuel conveying member; threadingly engaging the nozzle tip assembly with the fuel conveying member; and compressing the sealing element with a second abutting surface defined in the nozzle tip assembly by tightening the threaded engagement to seal a first junction between the nozzle tip assembly and the fuel conveying member.

In a fourth aspect, the present invention provides a fuel injection system comprising a fuel conveying member defining a nozzle receiving cavity having an axis, said nozzle receiving cavity first and second axially spaced-apart annular shoulders, a nozzle tip threadably engaged in said nozzle receiving cavity, said nozzle tip having third and fourth annular shoulders in opposed facing relationship with said first and second annular shoulders, respectively, and first and second sealing elements respectively axially compressed between said first and third annular shoulders and said second and fourth annular shoulders.

Further details of these and other aspects of the present invention will be apparent from the detailed description and figures included below.

### DESCRIPTION OF THE DRAWINGS

Reference is now made to the accompanying figures depicting aspects of the present invention, in which:

FIG. 1 is a cross-sectional view of a gas turbine engine comprising a fuel injection system according to the present invention;

FIG. 2 is a perspective view of a portion of the fuel injection system of FIG. 1, showing a fuel manifold ring with circumferentially distributed fuel nozzle tip assemblies; and

FIG. 3 is a cross-sectional view of a manifold ring and nozzle tip assembly of the fuel injection system of FIG. 1, showing an interior threaded engagement therebetween and C-shaped sealing elements.

### DETAILED DESCRIPTION OF THE PREFERRED EMBODIMENTS

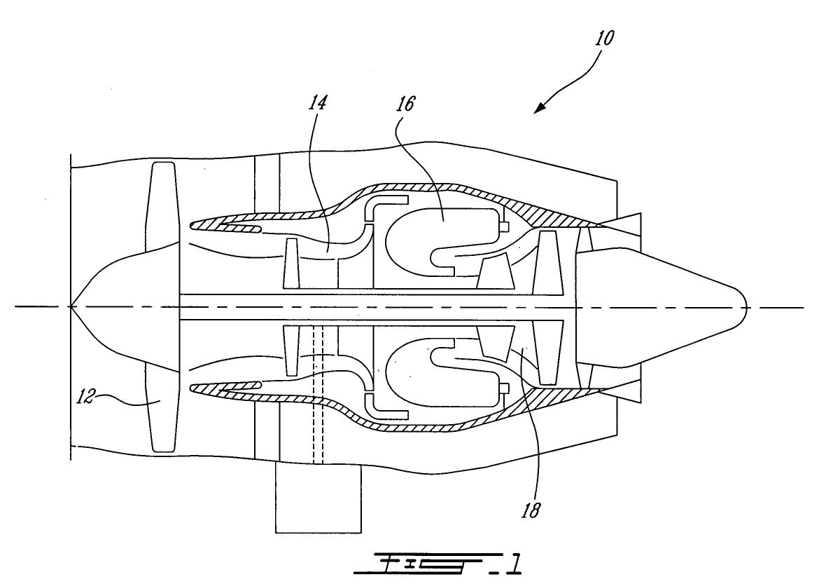

FIG. 1 illustrates a gas turbine engine 10 of a type preferably provided for use in subsonic flight, generally comprising in serial flow communication a fan 12 through which ambient air is propelled, a multistage compressor 14 for pressurizing the air, a combustor 16 in which the compressed air is mixed with fuel and ignited for generating an annular stream of hot combustion gases, and a turbine section 18 for extracting energy from the combustion gases.

Fuel is injected into the combustor 16 of the gas turbine engine 10 by a fuel injection system 20 which is connected in fluid flow communication with a fuel source (not shown) and is operable to inject fuel into the combustor 16 for mixing with the compressed air from the compressor 14 and ignition of the resultant mixture. The fan 12, compressor 14, combustor 16, and turbine 18 are preferably all concentric about a common central longitudinal axis 11 of the gas turbine engine 10.

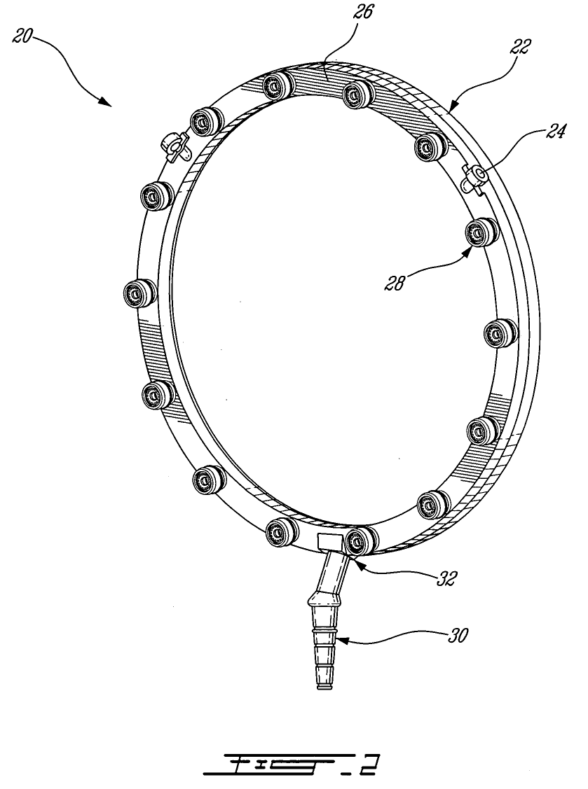

Referring to FIG. 2, the fuel injection system 20 comprises at least one fuel conveying member through which fuel flows. In the exemplary embodiment, the fuel injection system 20 includes an annular fuel manifold ring 22 which is mounted adjacent to the combustor 16 in the gas turbine engine 10. The fuel manifold ring 22 is preferably mounted to the combustor 16 or to surrounding support structure via several integral attachment lugs 24 which receive pins (not shown) engaged to the support structure. This provides a mounting mechanism which allows for thermal expansion of the fuel manifold ring 22 at high temperatures. The exterior of the manifold ring 22 comprises an outer heat shield 26 covering the ring. This provides the fuel manifold ring 22 thermal protection from the high temperature environment of the combustor 16.

A plurality of fuel injecting nozzle tip assemblies 28 are provided about the circumference of the fuel manifold ring 22. The nozzle tip assemblies 28 atomize the fuel as it is injected into the combustor 16 for ignition when mixed with the compressed air therein. Fuel enters the annular fuel manifold ring 22 through a fuel inlet pipe 30, via inlet 32, and is distributed within the manifold ring 22 such that fuel flow is provided to each of the fuel nozzle tip assemblies 28. Notably, the manifold ring 22 includes at least one fuel transporting conduit defined therein (not shown).

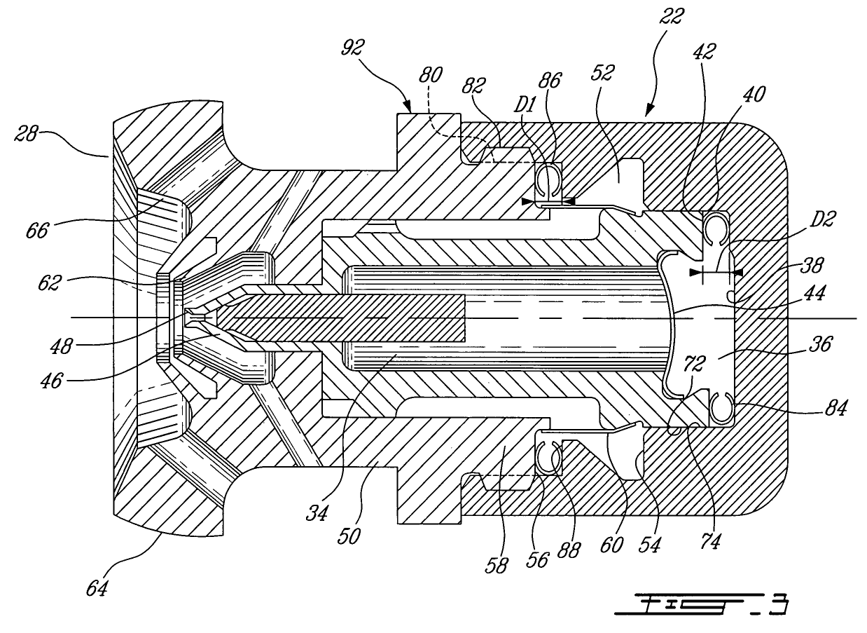

Referring to FIG. 3, the interior construction of a fuel manifold ring 22 and a fuel nozzle tip assembly 28 of the fuel injection system 20 is depicted. Particularly, the fuel nozzle assembly 28 projects axially (relative to the central longitudinal axis 11 of the gas turbine engine 10) outwardly from fuel manifold ring 22, and includes a primary distributor 34 for regulating a primary fuel flow provided by the manifold ring 22. A primary fuel passage 36 is defined between the primary distributor 34 and a first inside wall 38 of the manifold ring 22. More specifically, a substantially flat radial face 40 (i.e. perpendicular to the central longitudinal axis 11) of one end 42 of the primary distributor 34 is adapted to abut and compress a C-shaped seal 84 against the first inside wall 38 following assembly to provide a seal in the primary fuel flow passage 36 between the primary distributor 34 and the manifold ring 22, as will be explained in more details herein-below. Thus, a primary fuel flow is communicated from the manifold ring 22 into the primary fuel passage 36, which then flows through a perforated primary screen 44 supported by the primary distributor 34. The primary distributor 34 comprises a primary cone 46 adapted to eject the fuel through a primary fuel nozzle tip 48.

Typically, the fuel nozzle tip assembly 28 also comprises a secondary fuel swirler 50 disposed substantially concentrically about the primary distributor 34. A secondary fuel passage 52 is defined between the secondary fuel swirler 50 and a second inside wall 54 of the manifold ring 22. More specifically, the secondary fuel passage 52 is defined by the spaced relationship between a substantially flat radial face 56 (i.e. perpendicular to the central longitudinal axis 11) of one end 58 of the secondary fuel swirler 50 and the second inside wall 54. Thus, a secondary fuel flow is communicated from the manifold ring 22 into the secondary fuel passage 52, which then flows through a perforated secondary screen 60 supported by both the primary distributor 34 and the secondary fuel swirler 50. The secondary fuel swirler 50 is adapted to swirl the secondary fuel flow before it is ejected through an annular secondary fuel nozzle tip 62.

The fuel nozzle tip assembly 28 also typically comprises an outer air swirler 64 including a plurality of circumferentially spaced air passages 66 which convey air flow for blending with the primary and secondary fuel sprays issuing from the primary and secondary nozzle tips or spray orifices, 48 and 62 respectively, of the fuel nozzle tip assembly 28.

The fuel injection system 20 comprises an improved fuel conveying member and a nozzle tip assembly engagement. Particularly, the fuel conveying member, which is exemplified as a manifold ring 22, is threadedly engaged with each of the fuel nozzle tip assemblies 28. As can be seen in FIG. 3, the fuel manifold ring 22 has an annular threaded portion 80. Thus, the nozzle tip assembly 28 has a corresponding threaded portion 82 for threaded engagement with annular threaded portion 80 of the manifold ring 22. The threaded portion 82 is provided on an outer surface of the secondary fuel swirler 50. The mating threaded portions 80 and 82 act to fix the fuel nozzle tip assembly 28 to the manifold ring 22.

By providing a threaded design for the engagement between the fuel nozzle tip assemblies 28 and the manifold ring 22, a need exists to ensure that leakage does not occur through the threaded connection due to a difference in the thermal growth between the mating parts. Thus, the fuel injection system 20 comprises sealing elements 84 and 86 that replace the seals created by the conventional brazing joints.

Still referring to FIG. 3, it can be seen that the sealing elements 84 and 86 are provided in the primary and secondary fuel passages 36 and 52 respectively. The sealing elements 84 and 86 are preferably provided in the form of annular “C”-shaped seals made from a thin nickel based material adapted to sustain a predetermined amount of compression (QUESTION FOR THE INVENTOR: O-rings ARE NOT PERMISSIBLE DUE TO THE HIGH TEMPERATURE, WHAT MAKE C-SEAL MORE RESTIANT TO HIGH TEMPERATURES AND THUS SUITABLE FOR USE IN THE TIP ASSEMBLY? IS THE C-SHAPED ANYTHING TO DO WITH THAT? COULD OTHER TYPES OF SEAL BE USED?). C-seals made from nickel based material are adapted to sustain temperatures up to 1200° F. The sealing elements 84 and 86 could also be made out of other high temperature resistant materials. Also, a “W” shape or other compressible shape could be used. A “C” shape is preferable due to the small size of the seal. The sealing elements 84 and 86 act to seal the primary and secondary fuel passages 36 and 52 from leakage occurring through the junction between the nozzle tip assembly 28 and the manifold ring 22. More specifically, sealing element 86 is positioned adjacent threaded portions 80 and 82 in the secondary fuel passage 52.

The manifold ring 22 comprises an abutting member 88 projecting annularly inward (ie. perpendicular to the central longitudinal axis 11) in the secondary fuel passage 52 for enabling compressing of the sealing element 84. The abutting member 88 is adapted to be spaced from the substantially flat face 56 of end 58 of the secondary fuel swirler 50 a predetermined distance D1. The distance D1 is a tightly controlled clearance determined by factors such as engine size. The abutting member 88 is also preferably configured to take up as little space as possible in the secondary fuel passage 52 while maintaining the structural integrity of the manifold ring 22 when in compression.

As shown in FIG. 3, the sealing element 86 is compressed between the abutting member 88 and the substantially flat face 56 such that it is compressed in a direction parallel to the central longitudinal axis 11 of the engine 10. In greater detail, the compressive axial force causes the free ends of the “C” sealing element 86 to move closer together. Notably, sealing element 86 is not shown fully compressed. In such a case, the top curved portion of the “C” sealing element 86 would abuts the manifold ring 22. Thus, pressing the sealing member 86 against two surfaces impedes fuel leakage from occurring out of the secondary fuel passage 52 via the threaded engagement.

Still referring to FIG. 3, it can be seen that sealing element 84 is compressed between the first inside wall 38 of the manifold ring 22 and flat face 40 of end 42 of the primary distributor 34 in the primary fuel passage 36. In this exemplary embodiment the axial length of the primary distributor 34 has been shortened so as to space the end face 40 from the first inside wall 38 such that a distance D2 is defined therebetween. The distance D2 is also a tightly controlled clearance determined by factors such as engine size. The “C” sealing element 84 is compressed in a direction parallel to the central longitudinal axis 11 of the engine 10 and reacts as described above for sealing element 86. Notably, sealing element 84 is not shown fully compressed. In such a case, the top curved portion of the “C” sealing element 84 would abut the manifold ring 22 at an exterior diameter of the primary fuel passage 36 and prevent fuel from leaking out thereof through joint 90 of the mating members. It can be seen from FIG. 3 that joint 90 is created when annular outer surface 72 of the primary distributor 34 comes into contact with the first inside annular surface 74 of the manifold ring 22 extending substantially axially between the primary and secondary fuel passages 36 and 52. Thus, sealing element 84 prevents fuel from the primary fuel passage 36 from leaking into the secondary fuel passage 52.

Notably, in the present particular embodiment, the manifold ring 22 does not need to be modified to accommodate sealing element 84 in the primary fuel passage 36 as is the case with abutting member 88 for sealing member 86.

As described above, the improved fuel injection system 20 provides a simplified design for facilitating engagement of the fuel nozzle tip assemblies 28 to the fuel manifold ring 22. To assemble a fuel nozzle tip assembly 28 to the manifold ring 22, one must properly position the sealing elements 84 and 86 in the manifold ring 22 and subsequently thread the nozzle tip assembly 28 thereto via a nut and bolt type connection generally identified by reference numeral 92 in FIG. 3. The action of threading the parts together can be carried out quickly when compared to the brazing process of the prior art. As the parts are tightly threaded together, axial compressive forces are against the sealing elements 84 and 86.

Furthermore, by facilitating the assembly of the fuel nozzle tip assemblies 28 on the manifold ring 22 through a threaded design, the fuel nozzle tip assemblies 28 or the manifold ring 22 can be easily replaced. The above described configuration simplifies overall design and reduces cost. For example, if only a single fuel nozzle tip assembly 28 of the entire fuel injection system 20 is damaged, it can easily be unthreaded and replaced. Notably, the “C” sealing elements are not expensive and are easy to install.

The above description is meant to be exemplary only, and one skilled in the art will recognize that changes may be made to the embodiments described without department from the scope of the invention disclosed. For example, the fuel conveying member is exemplified as an annular fuel manifold ring on which the nozzle tip assemblies are directly mounted; however, the fuel conveying member can also be provided as nozzle stems which are traditionally required to link, in fluid flow communication, the nozzle tip assemblies with each distinct fuel manifold for each fuel inlet source. Furthermore, the fuel injection system may comprise only a single fuel passage defined between the fuel conveying member and the nozzle tip assembly. Still other modifications which fall within the scope of the present invention will be apparent to those skilled in the art, in light of a review of this disclosure, and such modifications are intended to fall within the appended claims.

What is claimed is:

1. A fuel injection system comprising a fuel conveying member and a nozzle tip threadably engaged thereto, the fuel conveying member and the nozzle tip defining at least a first fuel passage therebetween, and at least one sealing element engaged in the first fuel passage for sealing a first junction between the fuel conveying member and the nozzle tip assembly.

2. The fuel injection system as defined in claim 1, wherein the fuel conveying member includes at least a first abutting surface against which the sealing element is mounted in the first fuel passage.

3. The fuel injection system as defined in claim 2, wherein the nozzle tip includes at least a second abutting surface for compressing the sealing element against the first abutting surface.

4. The fuel injection system as defined in claim 1, wherein the first junction is defined between the engagement of an inner threaded portion of the fuel conveying member and an outer threaded portion of the nozzle tip.

5. The fuel injection system as defined in claim 1, wherein the sealing element is provided as a C-shaped annular seal, the C-shaped annular seal preventing fuel from leaking out of the first fuel passage.

6. The fuel injection system as defined in claim 1, wherein the fuel conveying member is a manifold ring and the fuel injection system comprises a plurality of circumferentially distributed nozzle tips threadably engaged with the manifold ring.

7. The fuel injection system as defined in claim 1, wherein a second sealing element is axially compressed between the nozzle tip and the fuel conveying member, the second sealing element being located radially outwardly of the first sealing element and axially downstream thereof relative to a fuel flow direction through the nozzle tip, the second sealing element sealing the threaded connection between the nozzle tip and the fuel conveying member from fuel flowing in a secondary fuel flow passage.

8. The fuel injection system as defined in claim 1, wherein the fuel conveying member defines a nozzle tip receiving cavity having a central axis, said fuel conveying member having first and second axially spaced-apart annular shoulders provided in said nozzle tip receiving cavity, said nozzle tip having corresponding axially spaced-apart annular shoulders, said first sealing element being axially compressed between said first annular shoulder and said third annular shoulder, and wherein a second sealing element is axially compressed between said second annular shoulder and said fourth annular shoulder, the shoulders being located upstream of the threaded connection between the nozzle tip and the fuel conveying member relative to a fuel flow through the nozzle tip.

9. A fuel injection system for a gas turbine engine comprising:
a manifold ring adapted for installation inside a gas turbine engine having a plurality of circumferentially distributed nozzle tip receiving sites, the manifold ring including at least one fuel transporting conduit defined therein in communication with each of the nozzle tip receiving sites;
a plurality of nozzle tip assemblies mounted about the manifold ring, each nozzle tip assembly being threadedly engaged in the nozzle tip receiving site and in fluid communication with the fuel transporting conduit;
at least a first fuel passage defined between the manifold ring and each nozzle tip assembly; and
at least one sealing element compressively engaged in the first fuel passage between a first compression surface defined by the manifold ring and a second compression surface defined by the nozzle tip assembly for sealing a first junction therebetween.

10. The fuel injection system as defined in claim 9, wherein the manifold ring includes an abutting member extending into the first fuel passage for supporting the sealing element in compression, the abutting member defining the first compression surface.

11. The fuel injection system as defined in claim 9, wherein the first junction is defined between the engagement of an inner threaded portion of the nozzle tip receiving site and an outer threaded portion of the nozzle tip assembly.

12. The fuel injection system as defined in claim 9, wherein the sealing element is provided as a C-shaped annular seal.

13. The fuel injection system as defined in claim 9, wherein each nozzle tip assembly threadedly engaged in each nozzle tip receiving site of the manifold ring define therebetween a secondary fuel passage, the secondary fuel passage defined adjacent the engagement of an inner threaded portion of the nozzle tip receiving site and an outer threaded portion of the nozzle tip assembly, the first sealing element is compressively engaged in the first fuel passage for preventing leakage from the first fuel passage into the secondary fuel passage, and a second sealing element is compressively engaged in the secondary fuel passage for preventing leakage from the secondary fuel passage through the threaded engagement.

14. The fuel injection system as defined in claim 13, wherein the first sealing element is compressively engaged in the first fuel passage between an inside end wall defined in the nozzle tip receiving site and an abutting end of the nozzle tip assembly.

15. The fuel injection system as defined in claim 13, wherein the second sealing element is compressively engaged in the secondary fuel passage between an abutting member of the manifold ring extending into the secondary fuel passage and an abutting end of the nozzle tip assembly.

16. A method of assembling a nozzle tip assembly to a fuel conveying member of a fuel injection system in a gas turbine engine, comprising the steps of:
positioning at least one sealing element in abutment with a first abutting surface defined in the fuel conveying member;
threadingly engaging the nozzle tip assembly with the fuel conveying member; and
compressing the sealing element with a second abutting surface defined in the nozzle tip assembly by tightening the threaded engagement to seal a first junction between the nozzle tip assembly and the fuel conveying member.

17. The method as defined in claim 16, wherein the sealing element is positioned adjacent a threaded portion of the fuel conveying member.

18. The method as defined in claim 16, wherein the first junction defines the threaded engagement.

19. A fuel injection system comprising a fuel conveying member defining a nozzle receiving cavity having an axis, said nozzle receiving cavity first and second axially spaced-apart annular shoulders, a nozzle tip threadably engaged in said nozzle receiving cavity, said nozzle tip having third and fourth annular shoulders in opposed facing relationship with said first and second annular shoulders, respectively, and first and second sealing elements respectively axially compressed between said first and third annular shoulders and said second and fourth annular shoulders.

20. A fuel injection system as defined in claim 19, wherein first, second, third and fourth annular shoulders are located axially upstream of a threaded engagement between the fuel conveying member and the nozzle tip relative to a flow of fuel through said nozzle tip.
